(19) United States
(12) Patent Application Publication
(10) Pub. No.: US 2003/0201732 A1
(43) Pub. Date: Oct. 30, 2003

(54) Lamp tube illumination stabilization device

(76) Inventors: Peng-Jung Lee, Tao Yuan Hsien (TW); Kun-Cheng Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/134,376

(22) Filed: Apr. 30, 2002

(51) Int. Cl. H05B 37/02

(52) U.S. Cl. 315/291; 315/224

(57) ABSTRACT

A lamp tube illumination stabilization device, mostly applicable to scanners, includes a lamp tube driver for controlling the illumination of the lamp tube, a sensor for detecting the change of the illumination, and a voltage controller for receiving a detection value of the sensor and controlling the power magnitude to the lamp tube driver according to comparison of the detection value with a predetermined value of the voltage controller.

### BACKGROUND OF THE INVENTION

1. Field of the Invention

The present invention relates to a lamp tube illumination stabilization device and, more particularly, to a stabilization device utilizing a illumination detection circuit to control and quickly stabilize the illumination of a lamp tube.

2. Description of Prior Arts

Increasingly improvement of the computer technology such as the emergence of printers, modems, scanners, digital cameras, or other peripherals brings many advantages to people in everyday life, and wherein the scanner is one of the most convenient tools, which can directly scan documents, reports, or photographs, then display them on a computer screen for further edition, and store the results into the computer for backup and management.

In a prior art scanner, in order to achieve a faster scanning speed, a lamp tube in the scanner is generally turned on all the time for the preparation of immediate scanning whenever required. FIG. 1 shows a schematic diagram of time versus the illumination and current of lamp tube. When the lamp tube's current is 5 mA, it takes 78 seconds to reach its stable state. When the lamp tube's current is 6 mA, it take 74 seconds to do the same. And, when the lamp tube's current is 10 mA, it's rising time is about 36 seconds. As shown as in the FIG. 1, the more the lamp tube's current, the higher the lamp tube's illumination and the shorter the time for the tube to be stable.

In order to save the time taken for the scanner from turn-on to stable state, the lamp tube in the scanner is usually turned on all the time. In this circumstance, the illumination of the lamp tube's can be expeditiously achieved if the lamp tube's current is chosen to be 10 mA; however, the power consumption will increase accordingly to bring about a serious burden.

FIG. 2 shows a schematic diagram illustrating the time versus illumination when the lamp tube's current is switched. After the lamp tube is turned on, the current is first raised to 10 mA to let the lamp tube's illumination exceed the stabilized illumination while the lamp tube's current is equal to 5 mA. Thereafter, the lamp tube's current is then lowered to 3 mA or less, and, as this result, it further takes another 25 seconds to rise again to the original illumination of the common lamp tube's current (because the internal gas and temperature in the lamp tube are not stable yet). Although this way can save some power consumption as compared to entirely being operated under 10 mA, the time for stabilizing the illumination of lamp tube eventually is not shortened.

Moreover, if the lamp tube is turned on all the time, the lamp tube's illumination will change due to the influence of temperature along with the operating time, hence leading to an unstable state. Consequently, the lifetime of the lamp tube will thus shorten, and the output quality of scanned image will be deteriorated if the lamp tube's illumination cannot be stable.

Accordingly, the illumination of the above lamp tube in a scanner will decrease gradually, and the time for stabilizing the illumination is too long. That is, the above lamp tube has inconvenience and drawbacks in practical use. The present invention aims to resolve the problems.

### SUMMARY OF THE INVENTION

The primary object of the present invention is to provide a lamp tube illumination stabilization device so that the lamp tube can expeditiously reach to its stable illumination state, and keep the lamp illumination stable, thereby obtaining a better output quality of scanned images. Moreover, the lamp tube can be turned off at any time if no use so as to save power consumption and extend the lifetime of lamp tube.

To achieve the above object, the present invention provides a lamp tube illumination stabilization device, which includes a lamp tube driver, a sensor, and a voltage controller. The lamp tube driver is connected to the lamp tube for controlling the illumination thereof. The sensor is used to detect the lamp tube's illumination. The voltage controller is respectively connected to the lamp tube driver and the sensor, and used for receiving the detection value of the sensor and controlling the power magnitude outputted to the lamp tube driver.

The various objects and advantages of the present invention will be more readily understood from the following detailed description when read in conjunction with the appended drawing, in which:

### BRIEF DESCRIPTION OF THE DRAWINGS

FIG. 1 is a schematic diagram illustrating the time versus illumination and the lamp tube's current;

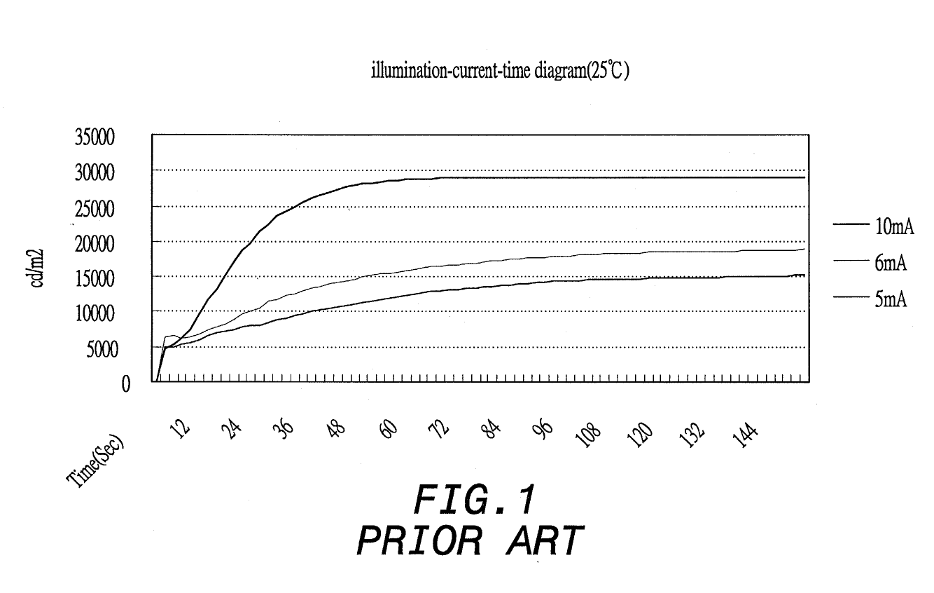

FIG. 2 is a schematic diagram illustrating the time versus illumination when the lamp tube's current is switched;

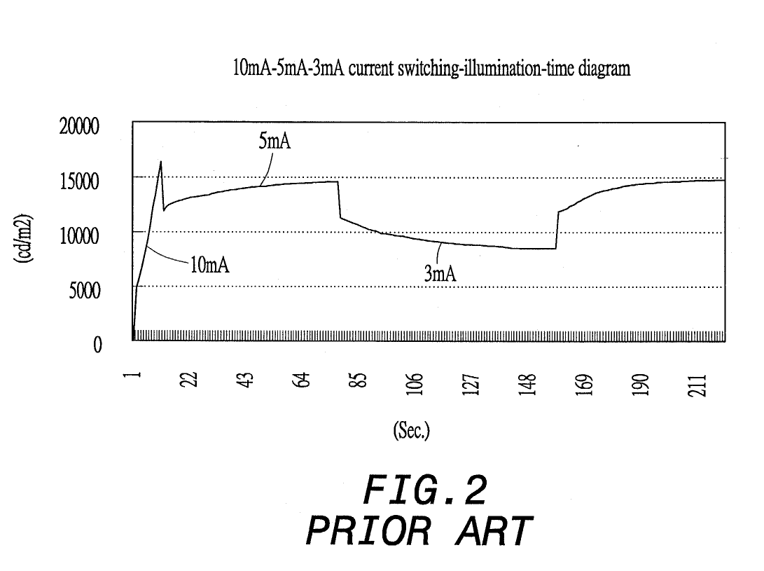

FIG. 3 is a block diagram of the control circuit of the present invention;

FIG. 4 is a schematic diagram of illustrating a DC input voltage versus lamp tube's current of the lamp tube driver of the present invention;

FIG. 5 is a schematic diagram of showing the relation between the DC input voltage of the lamp tube driver and the feedback voltage of the sensor of the present invention; and

FIG. 6 is a schematic diagram of illustrating the time versus illumination and current of lamp tube.

### DETAILED DESCRIPTION OF THE PREFERRED EMBODIMENT

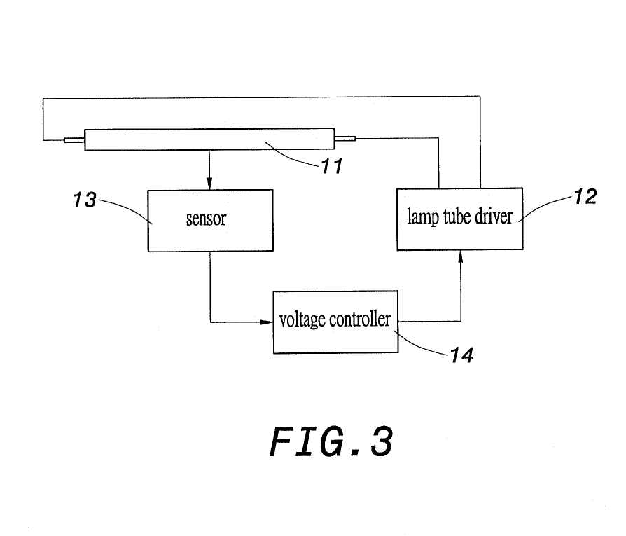

As shown in FIG. 3, the present invention relates to a lamp tube illumination stabilization device applied in a scanner for providing expeditious illumination stabilization of the light source of the scanner. The present invention, for a lamp tube 11, includes comprises a lamp tube driver 12, a sensor 13, and a voltage controller 14.

The output terminal of the lamp tube driver 12 is connected to the lamp tube 11 to control the illumination of the lamp tube 11.

The sensor 13 is used for detecting the change of illumination of the lamp tube 11 and outputting a feedback voltage according to the illumination change. The sensor 13 is disposed at one side of the lamp tube 11 of the scanner. Because the disposition position of the sensor 13 is not a key point in the present invention, it is not shown in the figure.

The voltage controller 14 is respectively connected to the input terminal of the lamp tube driver 12 and the output terminal of the sensor 13 to form a control circuit with the lamp tube 11. The voltage controller 14 is used for receiving the feedback voltage of the sensor 13 and controlling the power magnitude outputted to the lamp tube driver 12 according to comparison of the feedback voltage with a predetermined value in the voltage controller 14. The predetermined value is defined as the voltage value of keeping the illumination of light tube stable.

When the feedback voltage is larger than the predetermined value, it means that the illumination of the lamp tube 11 is too high. The power magnitude of voltage provided by the voltage controller 14 to the lamp tube driver 12 will be lowered to reduce the illumination of the lamp tube 11. On the contrary, when the feedback voltage is smaller than the predetermined value, it means that the illumination of the lamp tube 11 is too low. The power magnitude of voltage provided by the voltage controller 14 to the lamp tube driver 12 will be raised to increase the illumination of the lamp tube 11. No matter how the illumination of the lamp tube 11 varies with time or temperature, the illumination of the lamp tube 11 can be kept at a stable state, thereby maintaining the output quality of scanned images.

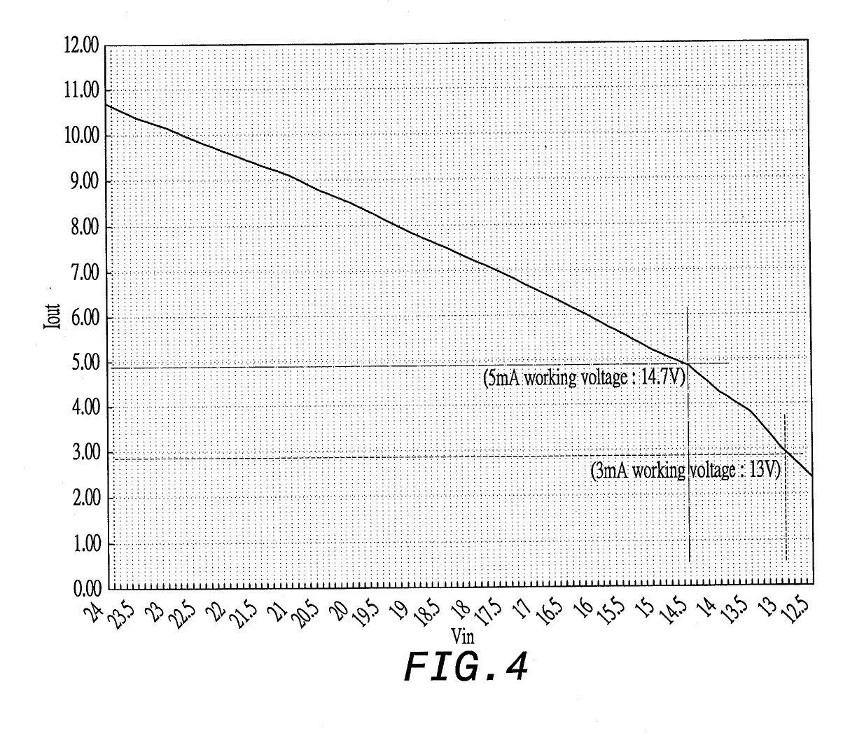

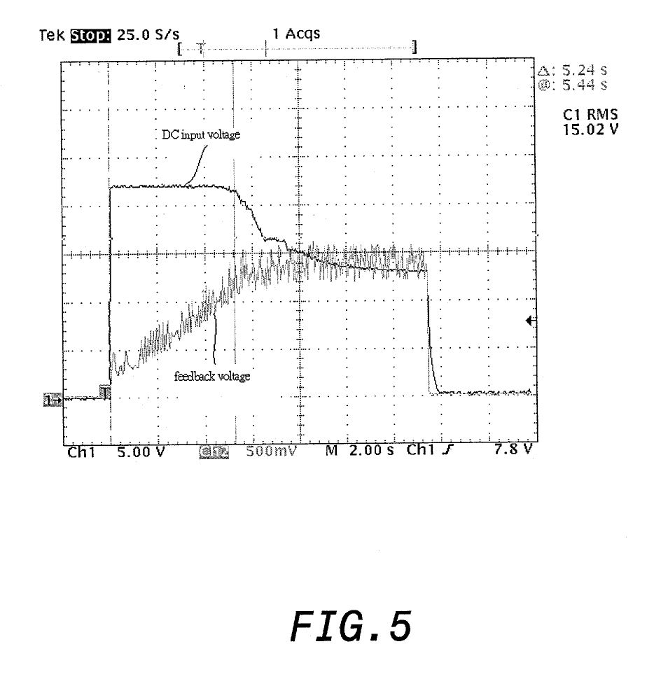

As shown in FIGS. 4 and 5, when the lamp tube 11 is just turned on, the voltage controller 14 initially provides a higher voltage exceeding the required voltage of about 20 mA in this embodiment to the lamp tube driver 12. The lamp tube 11 will expeditiously reach to its stable illumination state. Meanwhile, the feedback voltage of the sensor 13 will rise until the illumination of the lamp tube 11 is stable (i.e., the feedback voltage is equal to the predetermined voltage). Next, the voltage controller 14 provides the lamp tube driver 12 its required voltage, and the feedback voltage of the sensor 13 tends to be stable. The DC input voltage of the lamp tube driver 12 will vary based on a narrowing margin between the input DC voltage and the feedback voltage of the sensor 13. Until the lamp tube 11 is turned off, the feedback voltage of the sensor 13 and the DC input voltage of the lamp tube driver 12 are reduced to 0.

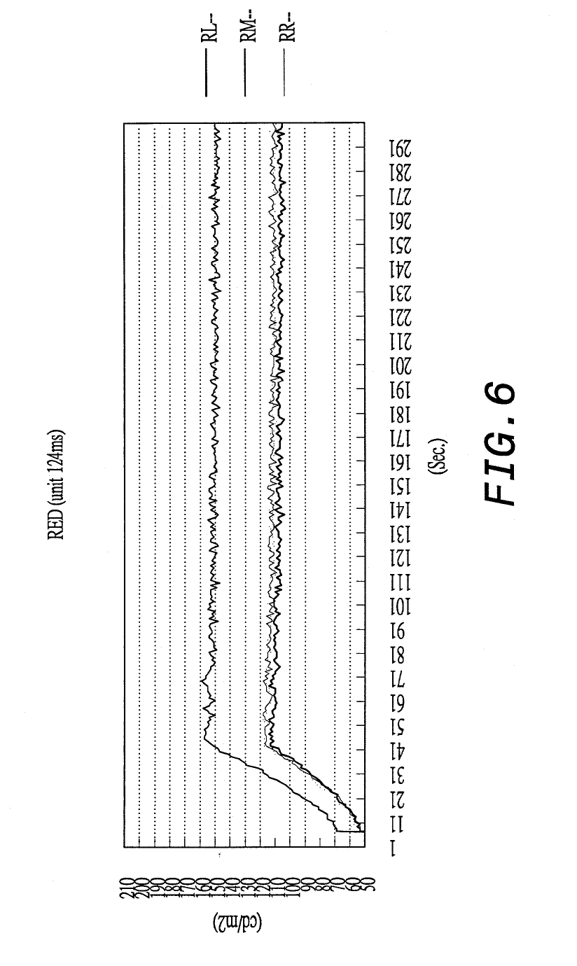

As shown in FIG. 6, it takes a shorter time from the lamp tube 11 from its turned-on to the stable state. Through the continuous detection of the illumination of the lamp tube 11 by the sensor 13, a certain stable illumination of the lamp tube 11 can be maintained without affecting the output quality of scanned images even the lamp tube 11 is turned on for a long time or the temperature of a lamp tube 11 gradually increases.

To sum up, the present invention has the following characteristics:

(1) A high current is inputted when the lamp tube is just turned on to shorten the time taken for stabilizing the lamp tube's illumination;

(2) After the lamp tube's illumination is stable, the sensor is used to detect the variation of illumination of the lamp tube. A stable illumination of the lamp tube can be maintained without affecting the output quality of scanned image even the lamp tube is turned on for a long time; and

(3) Because the time taken for stabilizing the illumination is very short, the lamp tube can be turned off when not in use, hence extending the lifetime of lamp tube and saving the power consumption.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A lamp tube illumination stabilization device, comprising:
a lamp tube driver connected to a lamp tube for controlling the illumination of said lamp tube;
a sensor for detecting the illumination of said lamp tube; and
a voltage controller respectively connected to said lamp tube driver and said sensor for receiving a detection value of said sensor and controlling a power magnitude to said lamp tube driver.

2. The lamp tube illumination stabilization device as claimed in claim 1, wherein said detection value is a feedback voltage.

3. The lamp tube illumination stabilization device as claimed in claim 2, further comprising a predetermined value for comparing with said detection value, and wherein if said detection value is larger than said predetermined value, said power magnitude to said lamp tube driver is lowered.

4. The lamp tube illumination stabilization device as claimed in claim 3, wherein if said detection value is smaller than said predetermined value, said power magnitude to said lamp tube driver is raised.

5. The lamp tube illumination stabilization device as claimed in claim 1, wherein when said lamp tube is just turned on, said voltage controller initially provides a voltage exceeding said predetermined voltage of said lamp tube until the illumination of said lamp tube reaches a stable value, and then said voltage controller provides said predetermined voltage to said lamp tube via said lamp tube controller.
